(19) United States
(12) Patent Application Publication
(10) Pub. No.: US 2026/0191360 A1
(43) Pub. Date: Jul. 9, 2026

(54) MIXING APPLIANCE INDEXING ASSEMBLY

(71) Applicant: Haier US Appliance Solutions, Inc., Wilmington, DE (US)

(72) Inventors: Alexander Miller, Louisville, KY (US); Tomas Garces, Louisville (KY)

(21) Appl. No.: 19/014,297

(22) Filed: Jan. 9, 2025

(51) Int. Cl. A47J 43/08; A47J 43/044; A47J 43/06; A47J 43/07

(52) U.S. Cl. CPC A47J 43/082; A47J 43/044; A47J 43/06; A47J 43/0711; A47J 2043/04463

(57) ABSTRACT

A mixing appliance includes a base and a drive assembly. The drive assembly includes a motor and a drive shaft. The motor is configured to rotate the drive shaft. Furthermore, the mixing appliance includes an indexing assembly. The indexing assembly includes a gearset. The gearset includes a first gear and a second gear. The first gear is rotatable by the drive assembly. The second gear is configured to be intermittently engaged by the first gear during rotation of the first gear. Additionally, the second gear is rotatable by the first gear during intermittent engagement of the second gear by the first gear. Furthermore, the indexing assembly includes a rotatable member. The rotatable member is rotatable by the second gear. Moreover, the rotatable member is configured to manipulate food content.

### FIELD OF THE INVENTION

The present disclosure relates generally to mixing appliances, such as stand mixers, or more specifically, to indexing assemblies of mixing appliances.

### BACKGROUND OF THE INVENTION

Stand mixers are generally used for performing automated mixing, churning, or kneading involved in food preparation. Typically, stand mixers include a motor configured to provide torque to one or more drive shafts. Users may connect various utensils or attachments to the one or more drive shafts, including whisks, spatulas, or the like. Generally, the attachments may include one or more devices or mechanisms for manipulating food content, such as a cutting blade for cutting the food content. For example, the cutting blade may be utilized to cut pasta noodles formed by a pasta extruder attachment into pasta noodle pieces. However, oftentimes attachments, such as the cutting blade described above, require manual operation, such as by a user of the stand mixer. For example, the user may be required to manipulate the cutting blade with his/her hands to cut the pasta noodles into pasta noodle pieces. This may be cumbersome and/or take time away from doing other tasks.

Accordingly, an indexing assembly for a mixing appliance would be desirable. More specifically, an indexing assembly for the mixing appliance that limits or prevents manual operation of the indexing assembly by the user of the mixing appliance would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a stand mixer is provided. The stand mixer defines a vertical direction, a lateral direction, and a transverse direction. The stand mixer includes a base. Additionally, the stand mixer includes a support column. The support column is coupled to the base. Furthermore, the support column extends vertically upward from the base. Moreover, the stand mixer includes a head. The head is coupled to an upper end of the support column. Additionally, the head extends from the support column above the base. Additionally, the stand mixer includes a drive assembly. The drive assembly includes a motor. Additionally, the drive assembly includes a drive shaft. The motor is configured to rotate the drive shaft. Furthermore, the stand mixer includes an attachment. The attachment is coupled to the head. The attachment includes an outlet through which food content exits the attachment. Moreover, the attachment includes an indexing assembly. The indexing assembly includes a gearset. The gearset includes a first gear. The first gear is rotatable by the drive assembly. Additionally, the gearset includes a second gear. The second gear is configured to be intermittently engaged by the first gear during rotation of the first gear. Furthermore, the second gear is rotatable by the first gear during intermittent engagement of the second gear by the first gear. Moreover, the indexing assembly includes a rotatable member. The rotatable member is rotatably by the second gear. Additionally, the rotatable member is configured to manipulate the food content exiting the attachment.

In another example aspect, a mixing appliance is provided. The mixing appliance includes a base. Additionally, the mixing appliance includes a drive assembly. The drive assembly includes a motor. Furthermore, the drive assembly includes a drive shaft. The motor is configured to rotate the drive shaft. Moreover, the mixing appliance includes an indexing assembly. The indexing assembly includes a gearset. The gearset includes a first gear. The first gear is rotatable by the drive assembly. Additionally, the gearset includes a second gear. The second gear is configured to be intermittently engaged by the first gear during rotation of the first gear. Furthermore, the second gear is rotatable by the first gear during intermittent engagement of the second gear by the first gear. Moreover, the indexing assembly includes a rotatable member. The rotatable member is rotatably by the second gear. Additionally, the rotatable member is configured to manipulate food content.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example embodiment of a stand mixer of the present disclosure.

FIG. 2 provides a perspective view of the example stand mixer of FIG. 1 with an example embodiment of an auxiliary attachment coupled to the stand mixer.

FIG. 3 provides a perspective view of the example auxiliary attachment of FIG. 2.

FIG. 4 provides a transparent perspective view of the example auxiliary attachment of FIG. 2.

FIG. 5 provides a perspective view of the example auxiliary attachment of FIG. 2 with a housing the auxiliary attachment removed.

FIG. 6 provides a front view of the example auxiliary attachment of FIG. 2.

### DETAILED DESCRIPTION OF THE INVENTION

Reference now will be made in detail to embodiments of the invention, one or more examples of which are illustrated in the drawings. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations may be made in the present invention without departing from the scope of the invention. For instance, features illustrated or described as part of one embodiment may be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

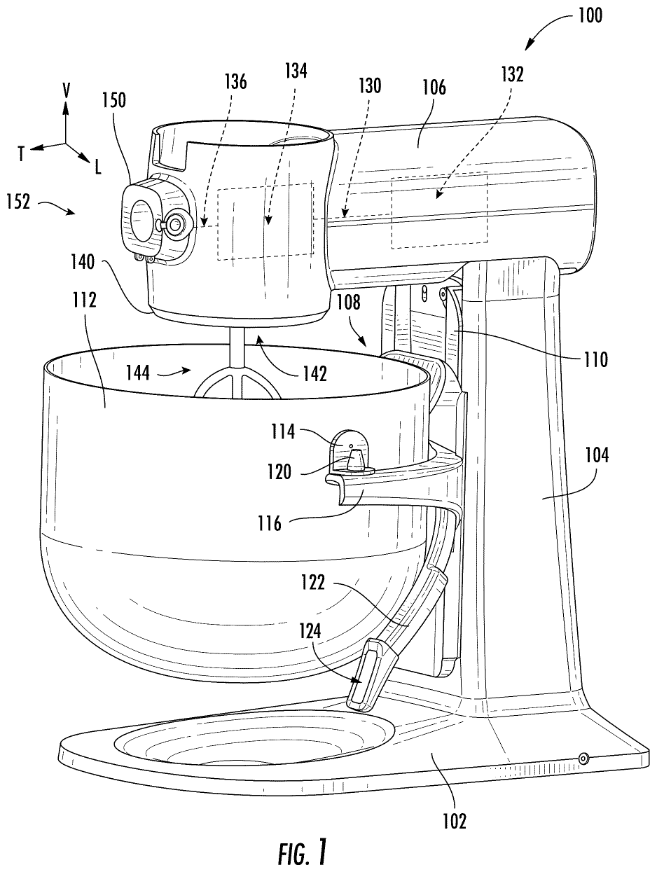

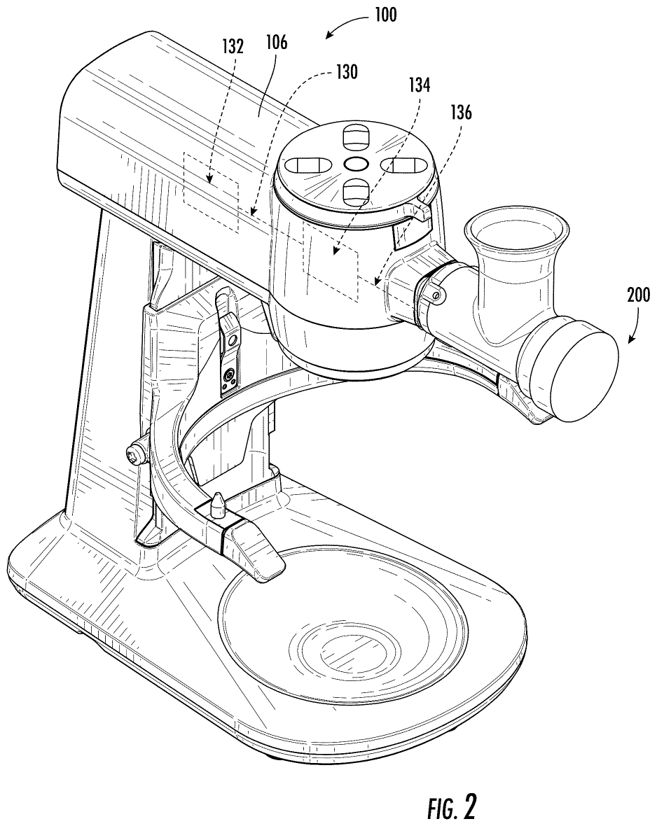

Referring to the figures, FIGS. 1 and 2 provide perspective views of a mixing appliance according to an example embodiment of the present subject matter. As shown in FIGS. 1 and 2 and as described herein, the mixing appliance is configured as a stand mixer 100. However, it will be appreciated that stand mixer 100 is provided by way of example only and that the present subject matter may be used in or with any suitable mixing appliance, such as a hand mixer, an immersion blender, a countertop blender, and/or the like, in alternative example embodiments. Moreover, with reference to each of FIGS. 1 and 2, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

As shown, stand mixer 100 includes a base 102 and may include a support post or column 104. The column 104 may include a bowl support 108. The bowl support 108 may slidably mount to a column rail 110, which is mounted to column 104. Additionally, components of bowl support 108 may extend outwardly above base 102, e.g., in the transverse direction T, and may hold bowl 112 above base 102, e.g., along the vertical direction V. The bowl 112 may be removably mounted on bowl support 108 via flanges 114. The flanges 114 may be on opposite sides of the bowl 112 with respect to the circumference of the bowl.

Additionally, as best illustrated in FIG. 1, bowl support 108 may include an arm 116 with a mounting spike 120. The arm 116 may hold bowl 112 via mounting spike 120, which may removably couple to flanges 114. For instance, each mounting spike 120 on arm 116 may be received within a respective flange 114 on bowl 112. One or more lift levers 122, such as two lift levers 122, may rotatably couple to arm 116. Thus, bowl 112 may be disposed between lift levers 122, e.g., along the lateral direction L. Each lift lever 122 may be positioned on a respective side of bowl 112, such that both a left-handed user and a right-handed user may comfortably operate lift levers 122. Each of the lift levers 122 may have one end, a distal end 124, cantilevered from support column 104. The distal end 124 may correspond to a handle for a user to grasp, push, or pull.

Furthermore, support column 104 may support a mixer head 106, which is positioned atop column 104. For example, as shown in FIG. 1, head 106 may be mounted to column 104, which is mounted to base 102. Thus, column 104 may extend between and connect base 102 and head 106, e.g., along the vertical direction V. The head 106 may extend outwardly above the base 102, e.g., in the transverse direction T. Furthermore, mixer head 106 may house a drive assembly 130 of stand mixer 100. The drive assembly 130 may include a motor 132, a gearbox 134, and/or a drive shaft 136. The motor 132 may be configured to rotate drive shaft 136 bi-directionally, or in a first rotational or circumferential direction (e.g., clockwise rotation) and a second rotational or circumferential direction (e.g., counterclockwise rotation) different from the first rotational direction. The structure and operation of drive components, e.g., motor, gearbox, and drive shaft, are understood by those of ordinary skill in the art. As such, these components are illustrated diagrammatically and are not discussed in comprehensive details herein for the sake of brevity and clarity.

Furthermore, head 106 may include a mixing attachment support 140. The mixing attachment support 140 may be located on a lower portion or underside 142 of head 106 and forward of support column 104 along transverse direction T. A rotating mixing attachment 144 may be removably coupled to the mixing attachment support 140. Additionally, drive shaft 136 may connect motor 132 with gearbox 134 and mixing attachment support 140 such that motor 132 may drive rotation of mixing attachment 144 when mixing attachment 144 is coupled to mixing attachment support 140. Furthermore, gearbox 134 may allow user selection of different rotating speeds for mixing attachment 144. The stand mixer 100 may include one or more controls for operations such as selectively powering motor 132, choosing the speed of rotation for mixing attachment 144, choosing the direction of rotation for mixing attachment 144, and/or other features. In certain embodiments, mixing attachment support 140 may accept more than one type of mixing attachment 144. Various types of mixing attachments may be used including e.g., whisks, paddles, dough hooks, beaters, and others for purposes of mixing ingredients within a bowl or other container supported by the base 102. During use, mixing attachment 144 may be rotated in a circular or planetary manner. Rotation in a planetary manner, as used herein, includes rotating both in a circular manner and rotating about an axis that moves in a circular manner.

An example operation of an exemplary embodiment of stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on stand mixer 100 to begin the process of mixing, kneading, beating, etc. The motor 132 rotates an attachment, such as mixing attachment 144, attached to stand mixer 100 to complete each of these processes.

Moreover, head 106 includes an auxiliary attachment support 150 located on a forward portion or frontside 152 of head 106 in the transverse direction T and forward of support column 104 in the transverse direction T. An auxiliary attachment 200 (FIG. 2), such as a pasta extruder attachment 202, may be removably coupled to auxiliary attachment support 150. For example, a removable pin (not shown) may couple pasta extruder attachment 202 to auxiliary attachment support 150. The drive shaft 136 may connect motor 132 with gearbox 134 and auxiliary attachment support 150 such that motor 132 may drive rotation of various components of the pasta extruder attachment 202 when pasta extruder attachment 202 is coupled to auxiliary attachment support 150. In certain embodiments, auxiliary attachment support 150 may accept more than one type of auxiliary attachment. For example, various types of auxiliary attachments may be used for the purpose of molding or forming dough into molded shapes or otherwise processing food.

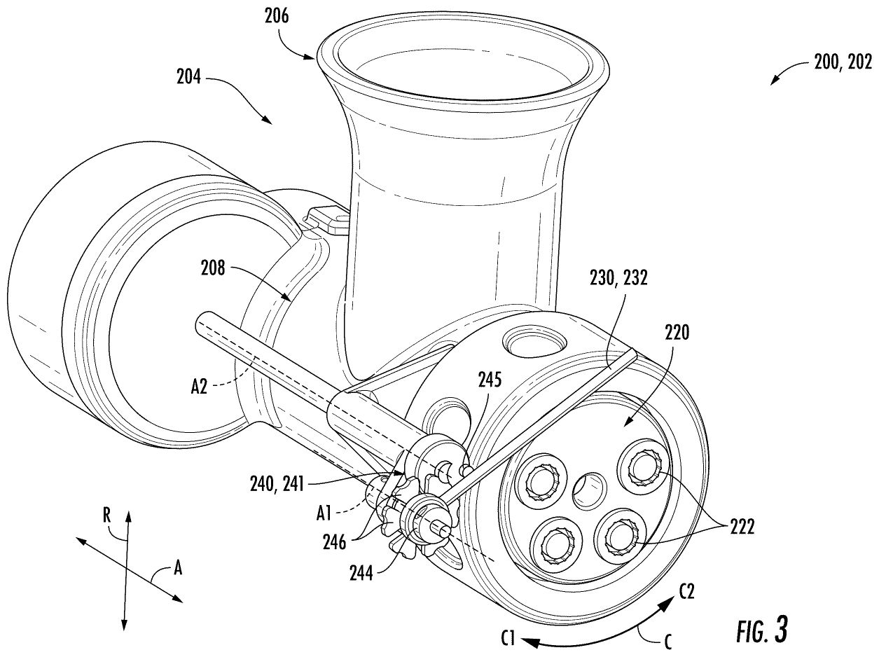

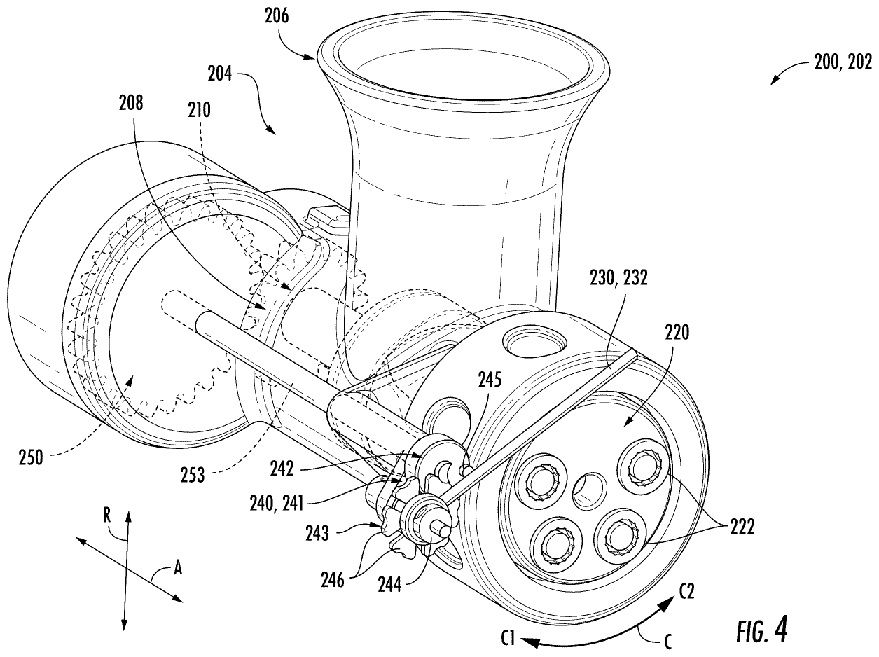

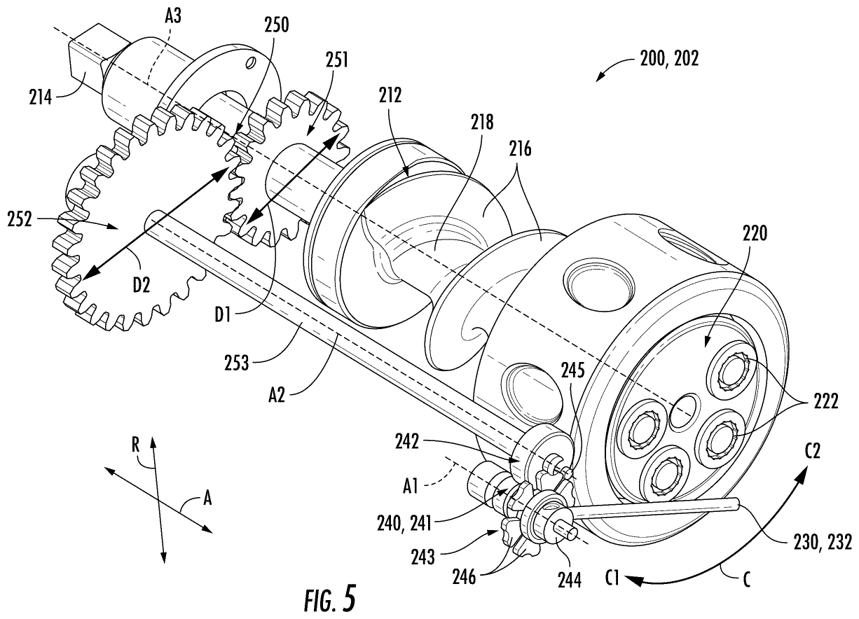

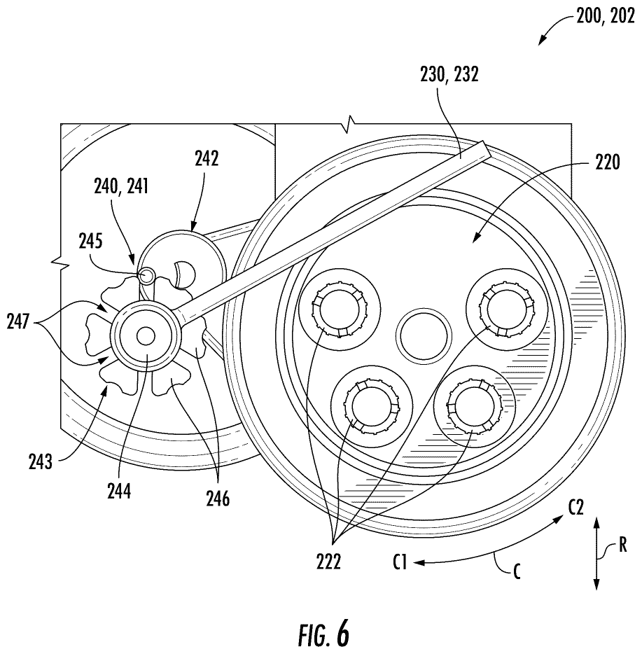

Referring now to FIGS. 3 through 6, differing views of an example auxiliary attachment 200 to be utilized with a mixing appliance, such as stand mixer 100, are provided. Specifically, FIG. 3 provides a perspective view of auxiliary attachment 200. FIG. 4 provides a transparent perspective view of auxiliary attachment 200 to illustrate an interior of auxiliary attachment 200. FIG. 5 provides a perspective view of auxiliary attachment 200 with a housing of auxiliary attachment removed 200 for illustrative purposes. FIG. 6 provides a front view of auxiliary attachment 200. The auxiliary attachment 200 generally defines a radial direction R, an axial direction A, and a circumferential direction C such that a cylindrical coordinate system is generally defined. The term “radial” refers to the relative direction that is substantially perpendicular to an axial centerline of auxiliary attachment 200. The term “axially” refers to the relative direction that is substantially parallel and/or coaxially aligned to an axial centerline of auxiliary attachment 200. The term “circumferentially” refers to the relative direction that extends around the axial centerline of auxiliary attachment 200. Although an exemplary construction of auxiliary attachment 200 is described herein, it should be appreciated that variations and modifications may be made to auxiliary attachment 200 while remaining within the scope of the present subject matter. Furthermore, although auxiliary attachment 200 is described herein as a pasta extruder attachment 202, it should be appreciated that auxiliary attachment 200 may be configured as any other suitable auxiliary attachment.

According to example embodiments, pasta extruder attachment 202 may include a housing 204. The housing 204 may house various internal components of pasta extruder attachment 202, some or all of which may be utilized to manipulate food content, e.g., dough. As such, housing 204 may include an inlet component, such as a hopper 206. The hopper 206 may extend from a main housing body 208. The food content may be received through hopper 206 within an interior 210 of main housing body 208 to be manipulated by various internal components of pasta extruder attachment 202. For example, pasta extruder attachment 202 may include a dough mover, such as a rotatable auger 212. As best illustrated in FIG. 4, rotatable auger 212 may be positioned within interior 210 of main housing body 208. The rotatable auger 212 may be mounted or otherwise coupled to a drive shaft extension 214 of pasta extruder attachment 202, which may be coupled to drive shaft 136 of drive assembly 130 of stand mixer 100 when pasta extruder attachment 202 is coupled to stand mixer 100. In this respect, drive shaft extension 214 and, thus, rotatable auger 212, may be rotatable by drive assembly 130 of stand mixer 100. As the rotatable auger 212 is rotated by drive assembly 130, dough within interior 210 of main housing body 208 may be moved or conveyed through main housing body 208 by a plurality of threads 216 wrapped around an auger body 218 of rotatable auger 212.

Additionally, pasta extruder attachment 202 may include an outlet component, such as a mold cover 220. One or more mold openings 222 may be defined through the mold cover 220 through which the food content exits pasta extruder attachment 202. As such, the conveyor component, such as the rotatable auger 212 described above, may apply force to the food content, e.g., dough, to push the dough through the mold opening(s) 222. As the dough is pushed through the mold opening(s) 222, the mold opening(s) 222 form the dough pushed through the mold opening(s) 222 into shapes, such as pasta noodle shapes.

According to example embodiments, indexing assembly 200 may include a rotatable member 230 configured to manipulate food content exiting pasta extruder attachment 202. For example, rotatable member 230 may be configured as or correspond to a cutting blade 232 utilized to cut or sever the pasta noodles exiting pasta extruder attachment 202 into pasta noodle pieces. In this respect, cutting blade 232 may be rotatable about a first axis of rotation A1, such as in a first circumferential direction C1, e.g., clockwise, and/or a second circumferential direction C2, e.g., counterclockwise, opposite the first circumferential direction C1, to cut the pasta noodles. Additionally, cutting blade 232 may be positioned externally of housing 204. For example, cutting blade 232 may be positioned adjacent to mold opening(s) 222 of mold cover 220 such that the pasta noodles exiting pasta extruder attachment 202 via mold opening(s) 222 are within a cutting path of cutting blade 232. In this respect, cutting blade 232 may cut the pasta noodles as the pasta noodles exit pasta extruder attachment 202. As described below, cutting blade 232 may be rotatable by drive assembly 130, which me be coupled or connected to cutting blade 232 by one or more gearsets.

According to example embodiments, indexing assembly 200 may include one or more gearsets 240. As described herein, the gearset(s) 240 may couple or connect rotatable member 230/cutting blade 232 to drive assembly 230 such that rotatable member 230/cutting blade 232 is rotatable by motor 132. For example, in some exemplary embodiments, indexing assembly 200 may include a first gearset 241, which is described herein as a Geneva gearset. The first gearset 241 may include a first gear 242 and a second gear 243. The rotatable member 230/cutting blade 232 may be fixedly coupled to second gear 243, such as to a hub 244 of second gear 243. In this respect, rotatable member 230/cutting blade 232 may be rotatable by second gear 243. As described below, first gear 242 may be rotatable by drive assembly 130, such as about a second axis of rotation A2, which may be parallel to the first axis of rotation A1, in the first and/or second circumferential directions C1, C2.

According to example embodiments, second gear 243 may be intermittently engaged by first gear 242 during rotation of first gear 242. As such, in some embodiments, one or more pins 245 may protrude from first gear 242 for engaging second gear 243 as first gear 242 rotates. For example, a single pin 245 may protrude from first gear 242. Likewise, two or more spacers 246 may protrude from second gear 243. A pin slot 247 may be defined between each adjacent pair of spacers 246, which may be configured to receive pin 245 within. For example, as best illustrated in FIGS. 3 through 6, six spacers 246 may be spaced apart along/around a perimeter of second gear 243. Additionally, six pin slots 247 may be defined between an adjacent pair of the six spacers 246. However, while described as six spacers 246 and six pin slots 247, it should be appreciated that second gear 243 may include any suitable number of spacers equal to or greater than two spacers and/or any suitable number of pin slots. For example, second gear 243 may include three or more spacers.

Moreover, second gear 243 may be rotatable by first gear 242 during the intermittent engagement of second gear 243 by first gear 242, such as about the first axis of rotation A1, in the first and/or second circumferential directions C1, C2. As first gear 242 rotates, pin 245 is intermittently received within a different one of pin slots 247. After pin 245 is received within one of pin slots 247, continued rotation of first gear 242 causes pin 245 to apply force to/push on one of the spacers 246 that pin 245 is positioned between. Such force applied by pin 245 rotates second gear 243 until pin 245 disengages from second gear 243 by exiting the slot 247 in which it was received. The first gear 242 then continues rotation until pin 245 is received within an adjacent pin slot 247 to continue intermittent engagement and, thus, intermittent rotation of second gear 243.

According to example embodiments, indexing assembly 200 may also include a second gearset or drive assembly gearset 250. The second gearset 250 may be coupled between drive assembly 130 and first gearset 241. The second gearset 250 may be configured to slow rotation of first gear 242 of first gearset 241 and, thus, second gear 243 of first gearset 241. For example, as best illustrated in FIG. 5, second gearset 250 may include a primary gear 251. The driving or primary gear 251 may be mounted or otherwise fixedly coupled to drive shaft 136 of drive assembly 130. As such, drive shaft 136 and primary gear 251 rotate together, such as about a third axis of rotation A3, parallel to the first and second axes of rotation A1, A2, in the first and/or second circumferential direction C1, C2, as motor 132 rotates drive shaft 136. Additionally, second gearset 250 may include a driven or secondary gear 252 engaged with primary gear 251. Thus, primary gear 251 rotates secondary gear 252, such as about the second axis of rotation A2 in the first and/or second circumferential direction C1, C2, as primary gear 251 is rotated. Furthermore, primary gear 251 may be fixedly coupled to first gear 242 of first gearset 241. For example, as illustrated in FIG. 5, an indexing assembly shaft 253 is fixedly coupled to primary gear 251 at one end and to first gear 242 of first gearset 241 at an opposite end. The secondary gear 252 may rotate indexing assembly shaft 253 and, thus, first gear 242/second gear 243 of first gearset 241 as primary gear 251 rotates secondary gear 252. As illustrated in FIG. 5, primary gear 251 and secondary gear 252 may be configured as spur gears having a gear ratio resulting in secondary gear 252 and, thus, first gear 242 of first gearset 241 rotating at a slower rotational speed than primary gear 251 and drive assembly 130. For example, primary gear 251 may define a first gear diameter D1 that is smaller or lesser than a second gear diameter D2 of secondary gear 252. Moreover, as best illustrated in FIG. 4, second gearset 250 and indexing assembly shaft 253 may be positioned within interior 210 of main housing body 208 of pasta extruder attachment 202. However, it should be appreciated that second gearset 250 and indexing assembly shaft 253 may be positioned at any other suitable location, such as externally of main housing body 208 of pasta extruder attachment 202.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer defining a vertical direction, a lateral direction, and a transverse direction, the stand mixer comprising:
a base;
a support column coupled to the base and extending vertically upward from the base;
a head coupled to an upper end of the support column and extending from the support column above the base;
a drive assembly including a motor and a drive shaft, the motor configured to rotate the drive shaft; and
an attachment coupled to the head, the attachment comprising:
an outlet through which food content exits the attachment; and
an indexing assembly, comprising:
a gearset including a first gear rotatable by the drive assembly and a second gear configured to be intermittently engaged by the first gear during rotation of the first gear, the second gear rotatable by the first gear during intermittent engagement of the second gear by the first gear; and
a rotatable member rotatable by the second gear, the rotatable member configured to manipulate the food content exiting the attachment.

2. The stand mixer of claim 1, wherein:
the first gear of the gearset comprises a pin configured to intermittently engage the second gear during rotation of the first gear;
the second gear of the gearset comprises two or more spacers, each adjacent pair of spacers of the two or more spacers collectively defining a pin slot therebetween, the pin slot configured to receive the pin of the first gear therein.

3. The stand mixer of claim 2, wherein the second gear is configured to be intermittently engaged by the first gear during rotation of the first gear via the pin of the first gear being received in one of the pin slots of the plurality of pin slots of the second gear to rotate the second gear.

4. The stand mixer of claim 2, wherein the first gear of the gearset comprises a single pin.

5. The stand mixer of claim 2, wherein:
the two or more spacers of the second gear of the gearset comprise three or more spacers; and
the three or more spacers collectively define between two pin slots and seven pin slots.

6. The stand mixer of claim 1, wherein the gearset of the indexing assembly comprises a Geneva gearset.

7. The stand mixer of claim 1, wherein the rotatable member of the indexing assembly comprises a cutting blade configured to cut the food content exiting the attachment.

8. The stand mixer of claim 7, wherein:
the attachment of the stand mixer comprises a pasta extrusion attachment; and
the cutting blade of the indexing assembly is configured to cut pasta into pasta pieces as the pasta exits the attachment.

9. The stand mixer of claim 1, wherein the attachment further comprises:
a rotatable indexing assembly shaft configured to rotate the first gear of the gearset of the indexing assembly; and
a drive assembly gearset coupled between the driveshaft of the drive assembly and the rotatable indexing assembly shaft, the drive assembly gearset configured to slow rotation of the rotatable indexing assembly shaft and thereby slow rotation of the first gear of the gearset of the indexing assembly relative to rotation of the drive shaft.

10. The stand mixer of claim 1, the attachment further comprising:
an auger mounted to the drive shaft and rotatable by the drive shaft for moving the food content through the outlet.

11. A mixing appliance, comprising:
a base;
a drive assembly including a motor and a drive shaft, the motor configured to rotate the drive shaft; and
an indexing assembly, comprising:
a gearset including a first gear rotatable by the drive assembly and a second gear configured to be intermittently engaged by the first gear during rotation of the first gear, the second gear rotatable by the first gear during intermittent engagement of the second gear by the first gear; and
a rotatable member rotatable by the second gear, the rotatable member configured to manipulate food content.

12. The mixing appliance of claim 11, wherein:
the first gear of the gearset comprises a pin configured to intermittently engage the second gear during rotation of the first gear;
the second gear of the gearset comprises two or more spacers, each adjacent pair of spacers of the two or more spacers collectively defining a pin slot therebetween, the pin slot configured to receive the pin of the first gear therein.

13. The mixing appliance of claim 12, wherein the first gear is configured to intermittently engage the second gear via the pin of the first gear being received in one of the pin slots of the plurality of pin slots of the second gear to rotate the second gear.

14. The mixing appliance of claim 12, wherein the first gear of the gearset comprises a single pin.

15. The mixing appliance of claim 12, wherein:
the two or more spacers of the second gear of the gearset comprise three or more spacers; and
the three or more spacers collectively define between two pin slots and seven pin slots.

16. The mixing appliance of claim 11, wherein the gearset of the indexing assembly comprises a Geneva gearset.

17. The mixing appliance of claim 11, wherein:
the mixing appliance further comprises an attachment coupled to the base, the attachment comprising an outlet through which the food content exits the attachment; and
the rotatable member of the indexing assembly comprises a cutting blade configured to cut the food content exiting the attachment.

18. The mixing appliance of claim 17, wherein:
the attachment comprises a pasta extrusion attachment; and
the cutting blade of the indexing assembly is configured to cut pasta into pasta pieces as the pasta exits the attachment.

19. The mixing appliance of claim 17, the attachment further comprising:
an auger mounted to the drive shaft and rotatable by the drive shaft for moving the food content through the outlet.

20. The mixing appliance of claim 11, further comprising:
a rotatable indexing assembly shaft configured to rotate the first gear of the gearset of the indexing assembly; and
a drive assembly gearset coupled between the driveshaft of the drive assembly and the rotatable indexing assembly shaft, the drive assembly gearset configured to slow rotation of the rotatable indexing assembly shaft and thereby slow rotation of the first gear of the gearset of the indexing assembly, relative to rotation of the drive shaft.
